(19) United States
(12) Patent Application Publication
(10) Pub. No.: US 2014/0324831 A1
(43) Pub. Date: Oct. 30, 2014

(54) APPARATUS AND METHOD FOR STORING AND DISPLAYING CONTENT IN MOBILE TERMINAL

(71) Applicant: Samsung Electronics Co., Ltd, Gyeonggi-do (KR)

(72) Inventor: Ga-Young Choi, Giheung-gu (KR)

(73) Assignee: Samsung Electronics Co., Ltd, Gyeonggi-do (KR)

(21) Appl. No.: 14/011,656

(22) Filed: Aug. 27, 2013

(30) Foreign Application Priority Data
Aug. 27, 2012 (KR) 10-2012-0093918

(51) Int. Cl. G06F 17/30

(52) U.S. Cl. CPC G06F 17/30595
USPC 707/722; 707/736

(57) ABSTRACT

A mobile terminal apparatus performs method for storing and displaying content in the mobile terminal. According to an aspect, if a request for displaying content among at least one piece of pre-stored content is received, related information corresponding to the content is searched for in at least one piece of pre-stored related information, and the content and the found related information are displayed.

### CROSS-REFERENCE TO RELATED APPLICATION(S) AND CLAIM OF PRIORITY

The present application is related to and claims the benefit under 35 U.S.C. §119(a) of a Korean patent application filed on Aug. 27, 2012 in the Korean Intellectual Property Office and assigned Serial No. 10-2012-0093918, the entire disclosure of which is hereby incorporated by reference.

### TECHNICAL FIELD

The present disclosure relates generally to a mobile terminal, and more particularly, to an apparatus and method for storing and displaying content in a mobile terminal.

### BACKGROUND

Mobile terminals, such as smart phones and tablet PCs, provide users with various useful functions through various applications. Accordingly, the mobile terminal has evolved to a device capable of using various kinds of information in addition to a voice call function through provision of various functions.

Specifically, the mobile terminal includes a camera and a microphone to create images or video data using the camera or to create audio data using the microphone. When displaying the created content (that is, images, video data, or audio data), the mobile terminal displays the date and time at which the content has been created together with the content. However, since the mobile terminal does not display additional information related to the content, a user cannot know any additional information related to the content although he/she can be aware of the creation date and time of the content.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies of the prior art, it is a primary object to provide an apparatus and method for storing additional information related to content in addition to the creation date and time of the content in a mobile terminal.

Also, another aspect of the present disclosure is to provide an apparatus and method for displaying additional information related to content together with the creation date and time of the content in a mobile terminal so that a user can know information related to the content.

Also, another aspect of the present disclosure is to provide an apparatus and method for specifying a file name of content based on the creation date and time of the content and additional information related to the content in a mobile terminal so that a user can know information related to the content by just looking at the file name of the content.

In accordance with an aspect of the present disclosure, there is provided an apparatus for storing content in a mobile terminal, including: a memory unit; and a controller configured to create, if a request for storing content is received, related information about the content based on location information of the mobile terminal, weather information, and schedule information registered by a user of the mobile terminal, and to store the content and the related information in the memory unit such that the related information corresponds to the content.

In accordance with another aspect of the present disclosure, there is provided an apparatus for displaying content in a mobile terminal, including: a memory unit configured to store at least one piece of content and at least one piece of related information corresponding to the at least one piece of content; and a controller configure to search for, if a request for displaying content among the at least one piece of content is received, related information corresponding to the content in the at least one piece of related information, and to display the content and the found related information.

In accordance with another aspect of the present disclosure, there is provided a method for storing content in a mobile terminal, including: if a request for storing content is received, creating related information about the content based on location information of the mobile terminal, weather information, and schedule information registered by a user of the mobile terminal; and storing the content and the related information such that the related information corresponds to the content.

In accordance with another aspect of the present disclosure, there is provided a method for displaying content in a mobile terminal, including: if a request for displaying content among at least one piece of pre-stored content is received, searching for related information corresponding to the content in at least one piece of pre-stored related information; displaying the content and the found related information.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a mobile terminal according to embodiments of the present disclosure;

FIG. 2 illustrates a block diagram of a controller according to embodiments of the present disclosure;

FIG. 3A illustrates a flowchart of a method for storing content in a mobile terminal according to a first embodiment of the present disclosure;

FIG. 3B illustrates a flowchart of a method for displaying content in a mobile terminal, according to a first embodiment of the present disclosure;

FIG. 4A illustrates a flowchart of a method for storing content in a mobile terminal, according to a second embodiment of the present disclosure;

FIG. 4B illustrates a flowchart of a method for displaying content in a mobile terminal, according to a second embodiment of the present disclosure;

FIGS. 5A and 5B illustrate flowcharts of a method for creating related information in a mobile terminal, according to embodiments of the present disclosure;

FIG. 6 illustrates a structure of metadata according to embodiments of the present disclosure;

FIG. 7 illustrates examples of screens on which content is displayed in a mobile terminal according to embodiments of the present disclosure; and

FIG. 8 illustrates a first file name specified based on related information by a mobile terminal according to embodiments of the present disclosure.

Throughout the drawings, like reference numerals will be understood to refer to like parts, components, and structures.

### DETAILED DESCRIPTION

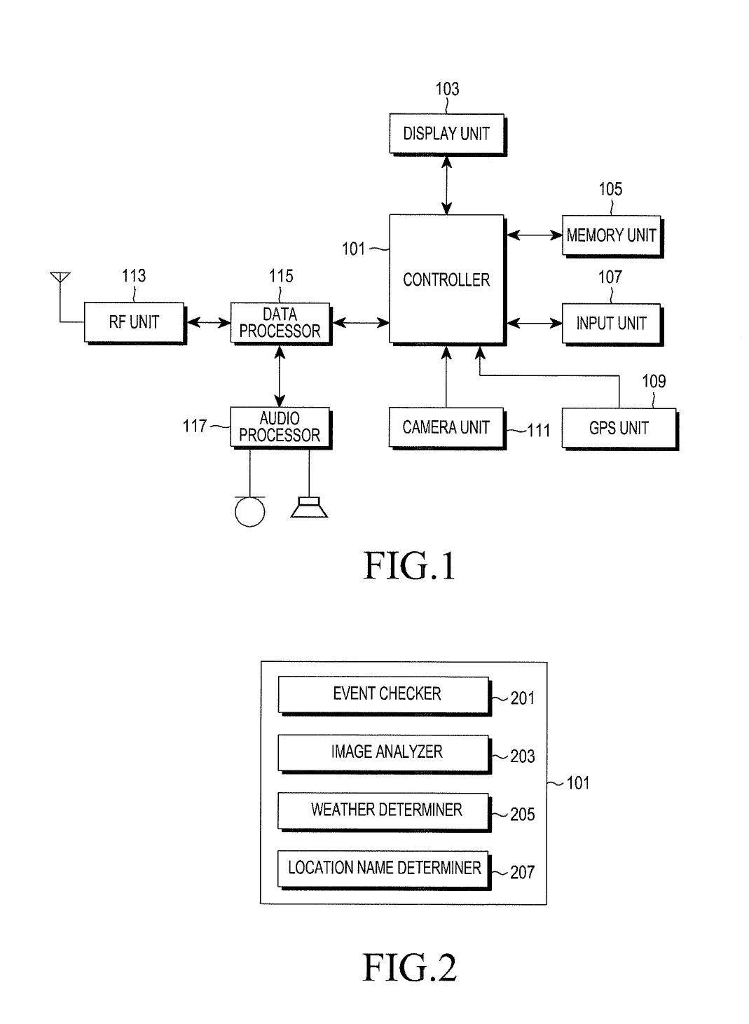

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this disclosure, a mobile terminal is a portable electronic device, and can be a video phone, a mobile phone, a smart phone, International Mobile Telecommunication 2000 (IMT-2000), a Wideband Code Division Multiple Access (WCDMA) terminal, a Universal Mobile Telecommunication Service (UMTS) terminal, a Personal Digital Assistant (PDA), a Mobile Multimedia Player (PMP), a Digital Multimedia Broadcasting (DMB) terminal, E-Book, Notebook, a Tablet PC, or a digital camera.

FIG. 1 illustrates a block diagram of a mobile terminal according to embodiments of the present disclosure.

Referring to FIG. 1, the mobile terminal includes a controller 101, a display unit 103, a memory unit 105, an input unit 107, a Global Positioning System (GPS) unit 109, a camera unit 111, a Radio Frequency (RF) unit 113, a data processor 115, and an audio processor 117.

The RF unit 113 performs a wireless communication function of the mobile terminal. More specifically, the RF unit 113 includes an RF transmitter for up-converting and amplifying the frequency of a signal to be transmitted, and an RF receiver for low-noise amplifying a received signal and down-converting the frequency of the received signal. The data processor 115 includes a transmitter for encoding and modulating a signal to be transmitted, and a receiver for demodulating and decoding a received signal. The data processor 115 can constitute a modem and a codec. The codec can include a data codec for processing packet data or the like, and an audio codec for processing audio signals such as voice.

The audio processor 117 performs a function of reproducing a received audio signal output from the data processor 115 through a speaker or of transmitting a transmission audio signal generated by a microphone to the data processor 115. The data processor 115 receives the transmission audio signal, processes the received transmission audio signal to create content (e.g., audio data), and outputs the created content to the controller 101.

The input unit 107 includes keys that enable a user to input numerical and text information, and functional keys for setting various functions. The display unit 103 displays an image signal as a screen, and displays data requested to be displayed by the controller 101. If the display unit 103 is implemented as a capacitive-type or resistive-type touch screen, the input unit 107 can include a minimum number of predetermined keys, and the display unit 103 can provide a part of the key input functions of the input unit 405.

The memory unit 105 includes a program memory and a data memory. The program memory stores booting and operating system (hereinafter, referred to as “OS”) for controlling the general operations of the mobile terminal, and the data memory stores various kinds of data created when the mobile terminal operates. Specifically, the memory unit 105 stores location information representing the location of the mobile terminal, weather information representing weather at the current location of the mobile terminal, image data about at least one person, and schedule information set by the user. The schedule information includes at least one event name stored in advance by the user, the name of a location at which the corresponding event will occur, and start and end times of the corresponding event.

The GPS unit 109 receives GPS signals from a plurality of GPS satellites, generates GPS coordinates based on the received GPS signals, and outputs the GPS coordinates to the controller 101. For example, the GPS coordinates can include values that represent a latitude and longitude. The camera unit 111 photographs a subject to create content (e.g., an image or video), and outputs the created content to the controller 101.

The controller 101 controls the entire operations of the mobile terminal. Specifically, when a request for storing content is received from a user, the controller 101 creates information (hereinafter, simply referred to as “related information”) related to the content, and stores the related information to correspond to the content. Thereafter, when a request for displaying the content is received, the controller 101 displays the related information together with the content through the display unit 103. Here, the related information includes at least one of: weather when the content has been created; the name of a location at which the mobile terminal has been located when the content has been created; the name of an event in which the user has participated when the content has been created; and the name(s) of a person(s) included in the content if the content is an image.

More specifically, according to a first embodiment, the controller 101 determines whether a request for storing content is received from a user. If a request for storing content is received, the controller 101 tries to create related information corresponding to the content requested to be stored. Then, the controller 101 determines whether related information corresponding to the content requested to be stored has been created. If the related information has been created, the controller 101 stores the content in the memory unit 105, and also stores the related information as metadata of the corresponding content in the memory unit 105. Alternatively, if no related information has been created, the controller 101 stores the content in the memory unit 105.

Thereafter, the controller 101 determines whether a request for displaying specific content among at least one piece of content stored in the memory unit 105 is received from the user. If a request for displaying specific content is received, the controller 101 searches for metadata of the specific content, and analyzes the found metadata. Based on the results of the analysis, the controller 101 determines whether the metadata includes related information about the specific content. If the metadata includes related information about the specific content, the controller 101 displays the content and the related information. For example, if the related information includes an event name, weather, and a location name, the controller 101 can display the content, and then display the event name, the weather, and the location name on the displayed content. Alternatively, if the metadata includes no related information, the controller 101 displays the content.

According to a second embodiment, the controller 101 determines whether a request for storing content is received from a user. If a request for storing content is received, the controller 101 tries to create related information corresponding to the content requested to be stored. Then, the controller 101 determines whether the related information corresponding to the content requested to be stored has been created.

If the related information has been created, the controller 101 specifies a first file name of the content using the related information and the date and time at which the content is requested to be stored. Then, the controller 101 stores the content with the first file name in the memory unit 105, and also stores the related information as metadata of the content in the memory unit 105. For example, if the related information includes an event name, weather, and a location name, the controller 101 can specify a first file name including the event name, the weather, the location name, and the date and time at which the content is requested to be stored. Alternatively, if no related information has been created, the controller 101 specifies a second file name using the date and time at which the content is requested to be stored. Then, the controller 101 stores the content with the second file name in the memory unit 105. For example, the controller 101 can specify a second file name including the date and time at which the content is requested to be stored.

Thereafter, the controller 101 determines whether a request for displaying specific content among at least one piece of content stored in the memory unit 105 is received from the user. If a request for displaying specific content is received, the controller 101 searches for metadata of the specific content, and analyzes the found metadata. Based on the results of the analysis, the controller 101 determines whether the metadata includes related information about the specific content. If the metadata includes related information about the specific content, the controller 101 displays the content and the related information. Alternatively, the controller 101 can display the related information together with the content for a predetermined time period, and when the predetermined time period has elapsed, the controller 101 can display only the content without displaying the related information. The predetermined time period can be set to an arbitrary time period in the range from 2 to 10 seconds. For example, if the related information includes an event name, weather, and a location name, the controller 101 can display the content, and then display the event name, the weather, and the location name on the displayed content. Alternatively, if the metadata includes no related information, the controller 101 displays the content.

FIG. 2 is a block diagram of the controller 101 according to embodiments of the present disclosure.

Referring to FIG. 2, the controller 101 includes an event checker 201, an image analyzer 203, a weather determiner 205, and a location name determiner 207. When trying to create related information, the controller 101 creates related information using the event checker 201, the image analyzer 203, the weather determiner 205, and the location name determiner 207.

If content is an image, the image analyzer 203 analyzes the image to determine whether the image includes a face image. If it is analyzed that the image includes no face image, the image analyzer 203 terminates operation of analyzing the image. At least one pre-stored face image corresponds to at least one person name stored in the address book of the mobile terminal. If it is analyzed that the image includes a face image, the image analyzer 203 extracts the face image from the image, and searches for at least one face image in the memory unit 105. Then, the image analyzer 203 compares the extracted face image to the found at least one face image to then determine whether the extracted face image is identical to the found at least one face image. If the extracted face image is identical to the found at least one face image, the image analyzer 203 searches for a person name corresponding to the found face image that is identical to the extracted face image. However, if the extracted face image is not identical to the found at least one face image, the image analyzer 203 terminates operation of analyzing the image.

The weather determiner 205 tries to search for weather information in the memory unit 105. Here, the weather information is received from a weather server providing weather information and can include weather corresponding to a plurality of regions and times, or weather regarding the current time and location of the mobile terminal. The weather can include at least one of a number of weather conditions, such as, Sunny, Cloudy, Foggy, Snow, and Rain. Also, the weather information can be received from the weather server and updated according to a request from a user or at regular time intervals.

If weather information is found from the memory unit 105, the weather determiner 205 can search for weather condition information corresponding to the current location and time of the mobile terminal in the found weather information. If no weather information is found from the memory unit 105, the weather determiner 205 terminates operation of determining weather.

The location name determiner 207 tries to search for location information. The location information includes GPS coordinates, and is updated according to a request from a user or at regular time intervals. If location information is found, the location name determiner 207 can search for a location name corresponding to the current location of the mobile terminal in the found location information. If no location information is found, the location name determiner 207 terminates operation of searching for a location name.

The event checker 201 tries to search for schedule information in the memory unit 105. The schedule information includes at least one event name stored in advance by a user, the name of a location at which the corresponding event will occur, and start and end times of the corresponding event. Then, the event checker 201 determines whether an event corresponding to a current time and the location name found by the location name determiner 207 is included in the found schedule information. If an event corresponding to the location name and the current time exists in the schedule information, the event checker 201 searches for the name of the corresponding event. However, if no event corresponding to the current time and the location name exists in the schedule information, the event checker 201 terminates operation of checking an event.

As such, if specific information (e.g., any one of an event name, a person name, weather, and a location name) is found by the event checker 201, the image analyzer 203, the weather determiner 205, and the location name determiner 207, the controller 101 creates related information including the specific information. However, if no specific information is found, the controller 101 creates no related information.

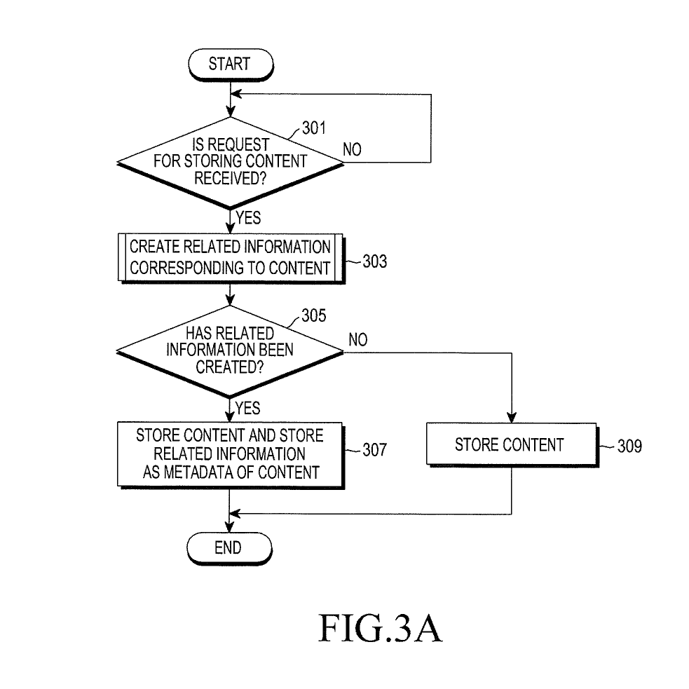

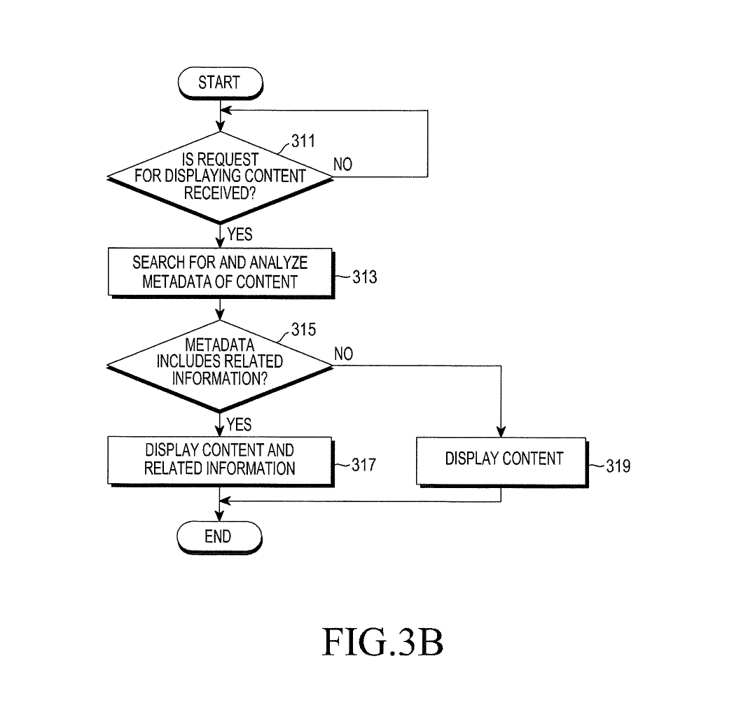

FIG. 3A illustrates a flowchart of a method for storing content in the mobile terminal, according to a first embodiment of the present disclosure.

Referring to FIGS. 1 and 3A, in step 301, the controller 101 determines whether a request for storing content is received from a user, and if a request for storing content is received, the controller 101 proceeds to operation 303. Here, the content can be any one of: image data, video data, and audio data. The image data and the video data can be created by the camera 111 according to a request from the user, and the audio data can be created by the data processor 115 according to a request from the user. If a request for storing content is received, the controller 101 proceeds to step 303, and otherwise, the controller 101 waits until a request for storing content is received from a user.

In step 303, the controller 101 tries to create related information corresponding to the content requested to be stored, and then proceeds to step 305. Here, the related information includes at least one of: weather when the content is created; the name of a location at which the mobile terminal is located when the content is created; the name of an event in which the user participates when the content is created; and the name(s) of a person(s) included in the content if the content is an image.

In step 305, the controller 101 determines whether related information corresponding to the content requested to be stored has been created. If related information has been created, the controller 101 proceeds to step 307, and otherwise, the controller 101 proceeds to step 309. In step 307, the controller 101 stores the content in the memory unit 105, and also stores the related information as metadata of the content in the memory unit 105. In step 309, the controller 101 stores the content in the memory unit 105.

FIG. 3B illustrates a flowchart of a method for displaying content in the mobile terminal, according to a first embodiment of the present disclosure.

Referring to FIGS. 1 and 3B, in step 311, the controller 101 determines whether a request for displaying specific content among at least one piece of content stored in the memory unit 105 is received from a user. If a request for displaying specific content is received, the controller 101 proceeds to step 313, and otherwise, the controller 101 waits until a request for displaying specific content is received.

In step 313, the controller 101 searches for metadata of the content requested to be displayed, analyzes the found metadata in order to determine whether the metadata includes related information, and then proceeds to step 315. In step 315, the controller 101 determines whether the metadata includes related information about the specific content. If the metadata includes related information about the specific content, the controller 101 proceeds to step 317, and otherwise, the controller 101 proceeds to step 319.

In step 317, the controller 101 displays the content and the related information. Alternatively, the controller 101 can display the related information together with the content for a predetermined time period, and when the predetermined time period has elapsed, the controller 101 can display only the content without displaying the related information. For example, if the related information includes an event name, weather, and a location name, the controller 101 can display the content, and then display the event name, the weather, and the location name on the displayed content. In step 319, the controller 101 displays the content.

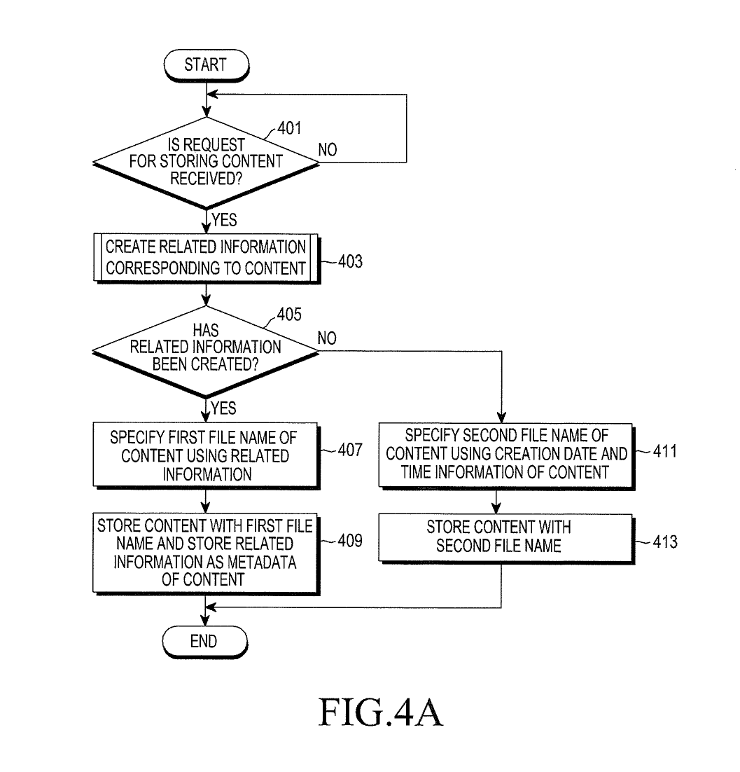

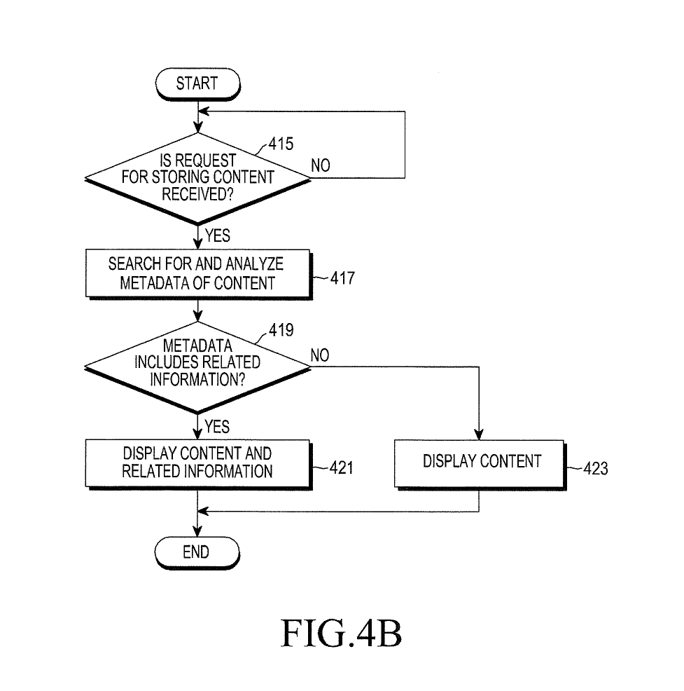

FIG. 4A illustrates a flowchart of a method for storing content in the mobile terminal, according to a second embodiment of the present disclosure.

Referring to FIGS. 1 and 4A, in step 401, the controller 101 determines whether a request for storing content is received from a user, and then proceeds to step 403. Here, the content can be any one of: image data, video data, and audio data. The image data and the video data can be created by the camera 111 according to a request from the user, and the audio data can be created by the data processor 115 according to a request from the user. If a request for storing content is received, the controller 101 proceeds to step 403, and otherwise, the controller 101 waits until a request for storing content is received from a user.

In step 403, the controller 101 tries to create related information corresponding to the content requested to be stored, and then proceeds to step 405. Here, the related information includes at least one of: weather when the content is created; the name of a location at which the mobile terminal is located when the content is created; the name of an event in which the user participates when the content is created; and the name(s) of a person(s) included in the content if the content is an image.

Then, in step 405, the controller 101 determines whether related information corresponding to the content requested to be stored has been created. If the related information has been created, the controller 101 proceeds to step 407, and otherwise, the controller 101 proceeds to step 411. In step 407, the controller 101 specifies a first file name of the content using the related information and the date and time at which the content is requested to be stored, and then proceeds to step 409. For example, if the related information includes an event name, weather, and a location name, the controller 101 can specify a first file name including the event name, the weather, the location name, and the date and time at which the content is requested to be stored. In step 409, the controller 101 stores the content with the first file name in the memory unit 105, and also stores the related information as metadata of the content in the memory unit 105.

In step 411, the controller 101 specifies a second file name of the content using the date and time at which the content is requested to be stored, and then proceeds to step 413. For example, the controller 101 can specify a second file name including the date and time at which the content is requested to be stored. Then, in step 413, the controller 101 stores the content with the second file name in the memory unit 105.

FIG. 4B illustrates a flowchart of a method for displaying content in the mobile terminal, according to a second embodiment of the present disclosure.

Referring to FIGS. 1 and 4B, in step 415, the controller 101 determines whether a request for displaying specific content among at least one piece of content stored in the memory unit 105 is received from the user. If a request for displaying specific content is received, the controller 101 proceeds to step 417, and otherwise, the controller 101 waits until a request for displaying specific content is received.

In step 417, the controller 101 searches for metadata of the specific content, analyzes the found metadata in order to determine whether the metadata includes related information, and then proceeds to step 419. In step 419, the controller 101 determines whether the metadata includes related information about the specific content. If the metadata includes related information about the specific content, the controller 101 proceeds to step 421, and otherwise, the controller 101 proceeds to step 423.

In step 421, the controller 101 displays the content and the related information. Alternatively, the controller 101 can display the related information together with the content for a predetermined time period, and when the predetermined time period has elapsed, the controller 101 can display only the content without displaying the related information. For example, if the related information includes an event name, weather, and a location name, the controller 101 can display the content, and then display the event name, the weather, and the location name on the displayed content. In step 423, the controller 101 displays the content.

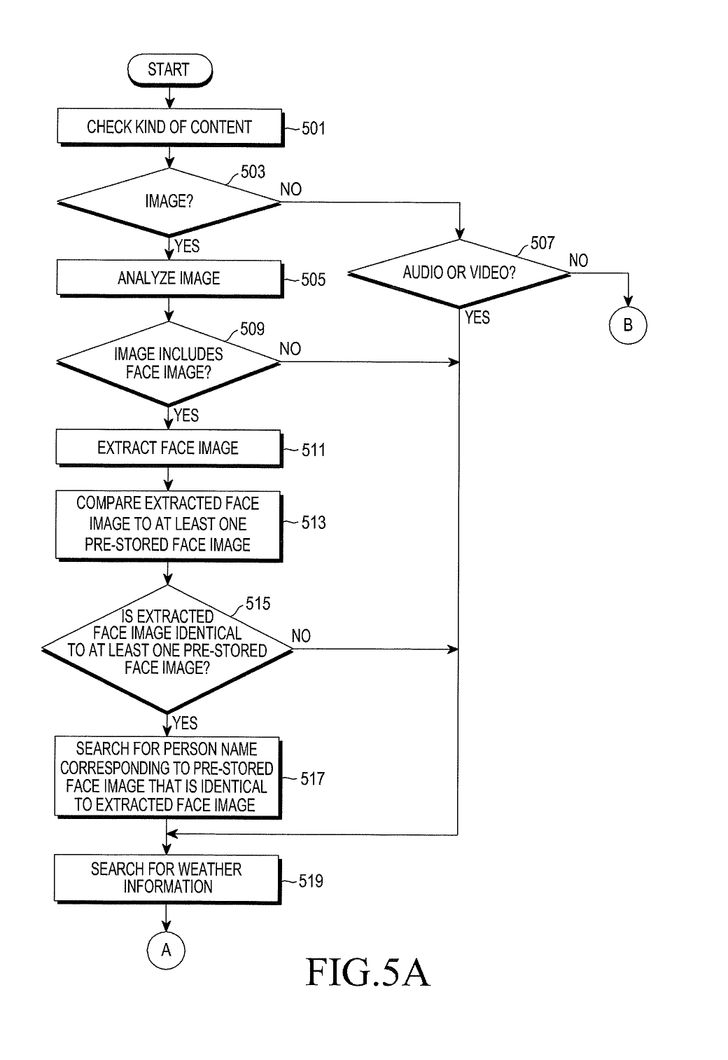

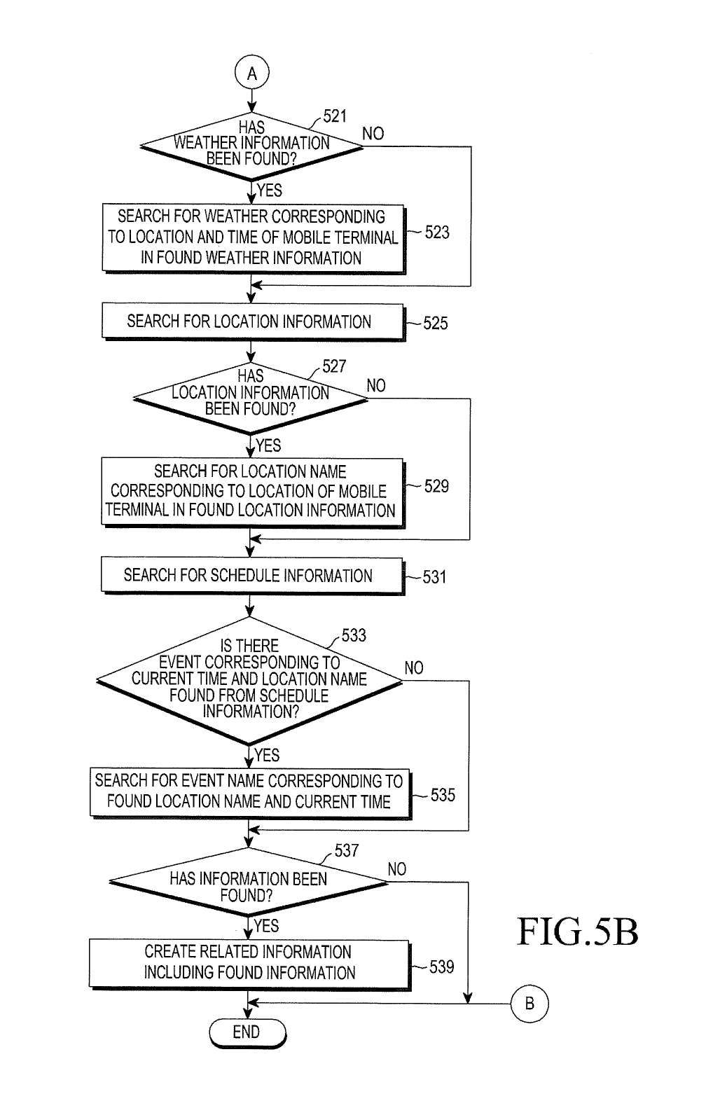

FIGS. 5A and 5B are flowcharts of a method for creating related information in the mobile terminal according to embodiments of the present disclosure. Specifically, FIGS. 5A and 5B are views for describing step 303 of FIG. 3A and step 403 of FIG. 4A in detail.

Referring to FIGS. 5A and 5B, in step 501, the controller 101 checks a kind of content requested to be stored, and then proceeds to step 503. In step 503, the controller 101 determines whether the content requested to be stored is an image. If the content is an image, the controller 101 proceeds to step 505, and otherwise, the controller 101 proceeds to step 507.

In step 507, the controller 101 determines whether the content is audio or video. If the content is audio or video, the controller 101 proceeds to step 519, and otherwise, the controller 101 terminates operation of creating related information.

In step 505, the controller 101 analyzes the image to determine whether the image includes a face image, and then proceeds to step 509. In step 509, the controller 101 determines whether the image includes a face image based on the results of the analysis. If the image includes a face image, the controller 101 proceeds to step 511; otherwise, the controller 101 proceeds to step 519.

In step 511, the controller 101 extracts the face image from the image, and then proceeds to step 513. In step 513, the controller 101 searches for at least one face image pre-stored in the memory unit 105, compares the extracted face image to the found face image, and then proceeds to step 515. The at least one pre-stored face image corresponds to at least one person name stored in the address book of the mobile terminal.

Then, in step 515, the controller 101 determines whether the extracted face image is identical to the found face image. If the extracted face image is identical to the found face image, the controller 101 proceeds to step 517; otherwise, the controller 101 proceeds to step 519. In step 517, the controller 101 searches for a person name corresponding to the found face image that is identical to the extracted face image, and then proceeds to step 519.

In step 519, the controller 101 tries to search for weather information stored in the memory 105, and then proceeds to step 521. The mobile terminal receives the weather information from a weather server providing weather information, and the weather information can include weather corresponding to a plurality of locations and times, or weather regarding the current time and location of the mobile terminal. The weather can include at least one of weather conditions, for example, Sunny, Cloudy, Foggy, Snow, and Rain. Also, the weather information can be received from the weather server and updated according to a request from a user or at regular time intervals

In step 521, the controller 101 determines whether weather information has been found from the memory unit 105. If weather information has been found, the controller 101 proceeds to step 523, and otherwise, the controller 101 proceeds to step 525. In step 523, the controller 101 searches for weather corresponding to the current location and time of the mobile terminal in the found weather information, and then proceeds to step 525.

In step 525, the controller 101 tries to search for location information in the memory unit 105, and then proceeds to step 527. Here, the location information includes GPS coordinates, and is updated according to a request from a user or at regular time intervals. In step 527, the controller 101 determines whether location information has been found. If location information has been found, the controller 101 proceeds to step 529; otherwise, the controller 101 proceeds to step 531. In step 529, the controller 101 searches for a location name corresponding to the current location of the mobile terminal in the found location information, and then proceeds to step 531.

In step 531, the controller 101 searches for schedule information in the memory unit 105, and then proceeds to step 533. The schedule information includes at least one event name stored in advance by the user, the name of a location at which the corresponding event will occur, and start and end times of the corresponding event. In step 533, the controller 101 determines whether there is an event corresponding to a current time and a location name found based on location information from the schedule information. If there is an event corresponding to the found location name and the current time, the controller 101 proceeds to step 535; and otherwise, the controller 101 proceeds to step 537. In step 535, the controller 101 searches for an event name corresponding to the found location name and the current time, and then proceeds to step 537.

In step 537, the controller 101 determines whether any information (for example, any one of an event name, a person name, weather, and a location name) related to the content has been found in steps 501 through 535. If information related to the content has been found, the controller 101 proceeds to step 539, and otherwise, the controller 101 terminates operation of creating related information. In step 539, the controller 101 creates related information including the found information.

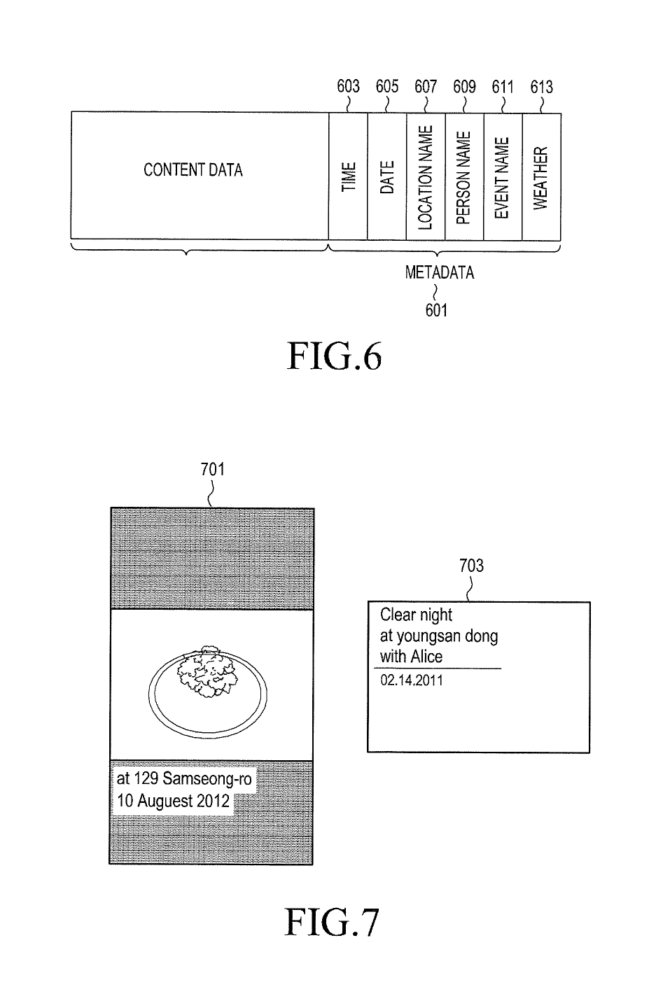

FIG. 6 illustrates a structure of metadata according to embodiments of the present disclosure.

Referring to FIG. 6, content data and metadata 601 related to the content data are shown. Here, the content data includes data about actual content, and the metadata 601 can include a date 603 and a time 605 at which the content data has been requested to be stored, a location name 607 representing the location of the mobile terminal when the content data has been requested to be stored, an event name 611 representing the name of an event in which a user of the mobile terminal has participated when the content data has been requested to be stored, and weather 613 when the content data has been requested to be stored. If the content data is an image, the metadata 601 can include a person name 611 corresponding to a face image included in the image.

FIG. 7 illustrates examples of screens on which content is displayed in the mobile terminal according to embodiments of the present disclosure.

Referring to FIG. 7, a screen 701 is a screen on which content is displayed together with related information about the content when the content is an image. For example, if related information about an image includes the name “129 Samseong-ro” of a location at which the mobile terminal has been located when the image has been stored, the controller 101 can display the location name “129 Samseong-ro” together with the image, like the screen 701.

A screen 703 is another screen on which content is displayed together with related information about the content when the content is an image. For example, if the related information includes weather (clear night), a location name (youngsan dong), and a person name (Alice) corresponding to a face image included in the image, the controller 101 (see FIG. 1) can display the weather, the location name, and the person name on the image, like the screen 703.

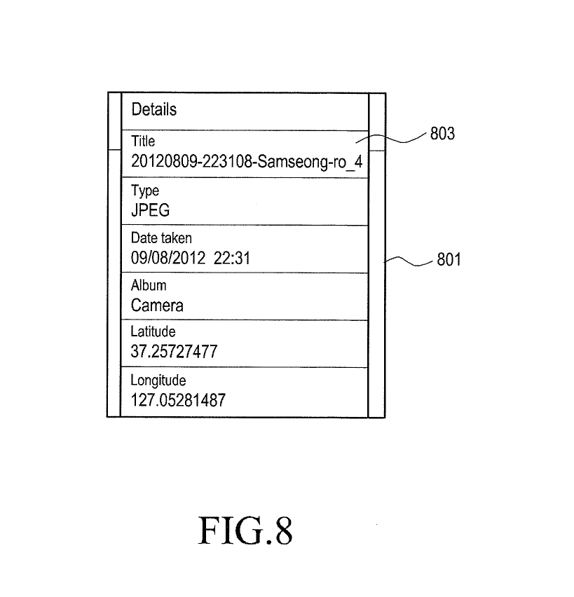

FIG. 8 illustrates a first file name specified based on related information by the mobile terminal according to an exemplary embodiment of the present disclosure.

Referring to FIG. 8, a window 801 is a window representing detailed information about a specific image. The window 801 includes a file name (20120809_{—}223108_Samseong-ro_{—}4) 803 specified based on related information about the specific image. “20120809” included in the file name 803 represents a date at which the specific image has been taken, and “223108” included in the file name 803 represents a time at which the specific image has been taken. Also, “Samseong-ro” included in the file name 803 represents the name of a location at which the specific image has been taken, and is included in related information about the specific image.

For example, if related information about a specific image includes the name “Samseong-ro” of a location at which the specific image has been taken, the controller 101 can specify a file name 803 of the specific image as “20120809_{—}223108_Samseong-ro_{—}4” based on the related information of the specific image and the date and time at which the specific image has been taken, and store the specific image with the file name “20120809_{—}223108_Samseong-ro_{—}4” 803.

Therefore, as described above, by storing additional information related to content in addition to the creation date and time of the content in a mobile terminal, a user can know information related to the content when the content is displayed. Also, by displaying additional information related to content together with the creation date and time of the content in a mobile terminal, a user can know information related to the content when the content is displayed. Also, by specifying a file name of content based on the creation date and time of the content and additional information related to the content in a mobile terminal, a user can know information related to the content by just looking at the file name of the content.

For example, instead of searching for a person name using at least one face image pre-stored in the memory unit 105 (see FIG. 1), the controller 101 (see FIG. 1) can search for a person name using a face image(s) stored in the server of a social network (e.g., Facebook or Twitter) to which a user has subscribed.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus configured to store content in a mobile terminal, comprising:
a memory unit; and
a controller configured to:
create, if a request for storing content is received, related information about the content based on location information of the mobile terminal, weather information, and schedule information registered by a user of the mobile terminal, and
store the content and the related information in the memory unit such that the related information corresponds to the content.

2. The apparatus of claim 1, wherein the related information includes at least one of weather when the content is stored, a name of location, an event name, and at least one name of at least one person included in the content.

3. The apparatus of claim 1, wherein the controller is configured to, if a request for storing content is received, determine a location name based on the location information of the mobile terminal, determine weather based on the weather information, determine an event name based on schedule information registered by the user, and create related information including the name of the location, the weather, and the event name.

4. The apparatus of claim 1, wherein the controller is configured to, if a request for storing the content is received when the content is an image, determine a location name based on the location information of the mobile terminal, determine weather based on the weather information, determine an event name based on the schedule information registered by the user, determine a person name corresponding to a face image included in the content, and create related information including the location name, the weather, the event name, and the person name.

5. The apparatus of claim 1, wherein the controller is configured to store the related information as metadata of the content.

6. The apparatus of claim 1, wherein the controller is configured to specify a file name of the content based on the related information, and store the content with the file name.

7. The apparatus of claim 1, further comprising;
a camera configured to create image data and video data according to a request from the user, and
a data processor configured to create audio data can according to a request from the user.

8. An apparatus configured to display content in a mobile terminal, comprising:
a memory unit configured to store at least one piece of content and at least one piece of related information corresponding to the at least one piece of content; and
a controller configure to search for, if a request for displaying content among the at least one piece of content is received, related information corresponding to the content in the at least one piece of related information, and to display the content and the found related information.

9. The apparatus of claim 8, wherein the related information includes at least one of weather when the content is stored, a name of location, an event name, and at least one name of at least one person included in the content.

10. The apparatus of claim 8, wherein the controller is configured to display the content and the related information for a predetermine time period, and when the predetermined time period has elapsed, the controller is configured to display the content without displaying the related information.

11. The apparatus of claim 8, further comprising;
a camera configured to create image data and video data according to a request from the user, and
a data processor configured to create audio data can according to a request from the user

12. A method for storing content in a mobile terminal, comprising:
if a request for storing content is received, creating related information about the content based on location information of the mobile terminal, weather information, and schedule information registered by a user of the mobile terminal; and
storing the content and the related information such that the related information corresponds to the content.

13. The method of claim 12, wherein the related information includes at least one of weather when the content is stored, a name of location, an event name, and at least one name of at least one person included in the content.

14. The method of claim 12, wherein the creating of the related information comprises:
if a request for storing the content is received, determining a location name based on the location information of the mobile terminal,
determining weather based on the weather information;
determining an event name based on the schedule information registered by the user; and
creating related information including the location name, the weather, and the event name.

15. The method of claim 12, wherein the creating of the related information comprises:
if a request for storing the content is received when the content is an image, determining a location name based on the location information of the mobile terminal;
determining weather based on the weather information,
determining an event name based on the schedule information registered by the user;
determining a person name corresponding to a face image included in the content; and
creating related information including the location name, the weather, the event name, and the person name.

16. The method of claim 12, wherein the storing of the related information comprises storing the related information as metadata of the content.

17. The method of claim 12, wherein the storing of the related information further comprises:
specifying a file name of the content based on the related information; and
storing the content with the file name.

18. A method for displaying content in a mobile terminal, comprising:
if a request for displaying content among at least one piece of pre-stored content is received, searching for related information corresponding to the content in at least one piece of pre-stored related information;
displaying the content and the found related information.

19. The method of claim 18, wherein the related information includes at least one of weather when the content is stored, a name of location, an event name, and at least one name of at least one person included in the content.

20. The method of claim 18, wherein the displaying of the content and the related information comprises displaying the content and the related information for a predetermine time period, and when the predetermined time period has elapsed, displaying the content without displaying the related information.
